(19) United States
(12) Patent Application Publication
(10) Pub. No.: US 2023/0307772 A1
(43) Pub. Date: Sep. 28, 2023

(54) BATTERY PACK

(71) Applicant: HONDA MOTOR CO., LTD., Tokyo (JP)

(72) Inventors: Hideki SAKAMOTO, Saitama (JP); Harumi TAKEDOMI, Saitama (JP)

(73) Assignee: HONDA MOTOR CO., LTD., Tokyo (JP)

(21) Appl. No.: 18/114,610

(22) Filed: Feb. 27, 2023

(30) Foreign Application Priority Data
Mar. 22, 2022 (JP) 2022-045561

(51) Int. Cl. H01M 50/289; H01M 50/211; H01M 50/503; H01M 50/507

(52) U.S. Cl. CPC H01M 50/289; H01M 50/211; H01M 50/503; H01M 50/507

(57) ABSTRACT

A battery pack includes a plurality of laminated cells stacked in a first direction of a horizontal direction, and a battery case accommodating the plurality of laminated cells. Each of the laminated cells includes a cell body portion, and a cell terminal extending from the cell body portion in a second direction orthogonal to the first direction of the horizontal direction and having a length in an upper-lower direction shorter than that of the cell body portion. The battery case includes a frame member facing the cell terminal in the second direction. A stopper member is disposed in at least one of a space at an upper side of the cell terminal and a space at a lower side of the cell terminal and between the cell body portion and the frame member.

### CROSS-REFERENCE TO RELATED APPLICATIONS

This application is based on and claims priority under 35 USC 119 from Japanese Patent Application No. 2022-045561 filed on Mar. 22, 2022.

### TECHNICAL FIELD

The present disclosure relates to a battery pack mounted on an electric vehicle or the like.

### BACKGROUND ART

In recent years, researches and development on secondary batteries which contribute to efficiency of energy have been carried out to ensure access to convenient, reliable, sustainable, and advanced energy for more people.

Laminated cells and square cells are known as the secondary batteries. For example, in battery packs disclosed in JP-A-2007-59088 and JP-A-2012-138268, a plurality of laminated cells are stacked. The plurality of laminated cells are accommodated in a case and modularized. In a battery pack disclosed in WO-A1-2019-039139, a plurality of square cells are stacked. The plurality of square cells are modularized by being surrounded in a horizontal direction by a pair of end plates and a binding bar coupling the end plates.

In order to save space, it is conceivable to stack a plurality of cells at a battery pack without modularization. When the plurality of cells are fixed to the battery pack, if the plurality of cells are modularized, a battery module may be fixed to the battery pack by bolts or the like as disclosed in WO-A1-2019-039139, but when a plurality of cells are not modularized, it is necessary to fix the plurality of cells to the battery pack in a different manner.

When a plurality of cells are stacked without being modularized, a restraining force does not act in a direction orthogonal to a stacking direction (also referred to as a stacking orthogonal direction) by merely restraining the plurality of cells in the stacking direction, and each cell may be displaced in the stacking orthogonal direction. In particular, when a plurality of laminated cells are stacked in the horizontal direction, each of the laminated cells is thin and light, and thus is likely to be displaced in the stacking orthogonal direction.

### SUMMARY

The present disclosure provides a battery pack capable of preventing displacement of laminated cells in a direction orthogonal to a stacking direction when the laminated cells are stacked in a horizontal direction. Further, the present disclosure contributes to efficiency of energy.

According to an aspect of the present disclosure, there is provided a battery pack including: a plurality of laminated cells stacked in a first direction of a horizontal direction; and a battery case accommodating the plurality of laminated cells, in which: each of the laminated cells includes: a cell body portion; and a cell terminal extending from the cell body portion in a second direction orthogonal to the first direction of the horizontal direction and having a length in an upper-lower direction shorter than that of the cell body portion; the battery case includes a frame member facing the cell terminal in the second direction; and a stopper member is disposed in at least one of a space at an upper side of the cell terminal and a space at a lower side of the cell terminal and between the cell body portion and the frame member.

According to the present disclosure, it is possible to prevent displacement of the laminated cells in the direction orthogonal to the stacking direction when the laminated cells are stacked in the horizontal direction.

### BRIEF DESCRIPTION OF DRAWINGS

FIG. 1 is a schematic perspective view illustrating an internal structure of a battery pack 1.

FIG. 2 is a schematic plan view schematically illustrating a flow of electricity in the battery pack 1.

FIG. 3 is a perspective view of a laminated cell 21.

FIG. 4 is a perspective view of a plurality of stacked laminated cells 21.

FIG. 5 is a perspective view illustrating a state in which a cell terminal 212 is coupled to an inter-cell coupling member 4.

FIG. 6 is a perspective view illustrating a state in which stopper members 7 are attached to the plurality of laminated cells 21.

FIG. 7 is a perspective view illustrating the stopper members 7 disposed in the vicinity of an intermediate horizontal frame 35.

FIG. 8 is a perspective view of a stopper member 7.

FIG. 9 is a partial top view illustrating the stopper member 7 disposed in the vicinity of the intermediate horizontal frame 35.

FIG. 10 is a cross-sectional view taken along a line A-A in FIG. 9.

FIG. 11 is a view corresponding to FIG. 10 when the stopper member 7 according to a modification is disposed in the vicinity of the intermediate horizontal frame 35.

### DESCRIPTION OF EMBODIMENTS

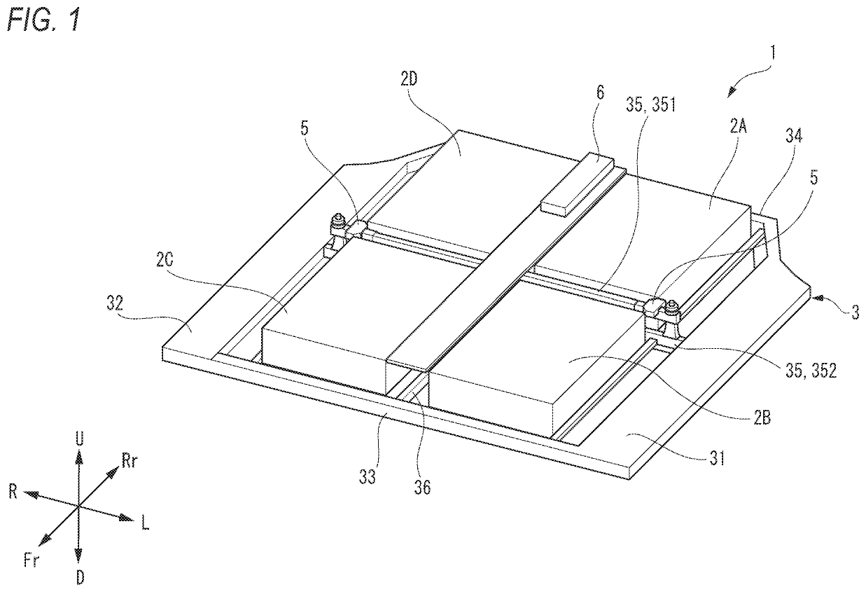

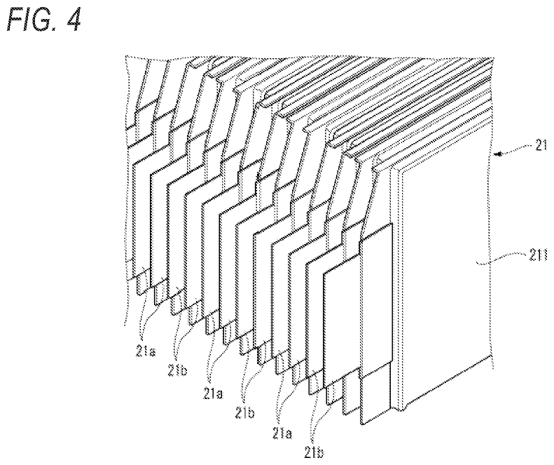

Hereinafter, an embodiment of the present disclosure will be described with reference to FIGS. 1 to 10. The drawings are to be viewed in directions of the reference signs, and in the following descriptions, for simplicity of description, front and rear, left and right, and upper and lower are set, and in the drawings, a front side is represented by Fr, a rear side is represented by Rr, a left side is represented by L, a right side is represented by R, an upper side is represented by U, and a lower side is represented by D for convenience.

(Battery Pack)

As illustrated in FIGS. 1 to 4, a battery pack 1 according to the embodiment of the present disclosure includes a plurality of laminated cells 21 stacked in a horizontal direction (in the embodiment, a left-right direction), and a battery case 3 accommodating the plurality of laminated cells 21, and is disposed under a floor (on a lower side of a floor panel) of a vehicle (not illustrated), for example.

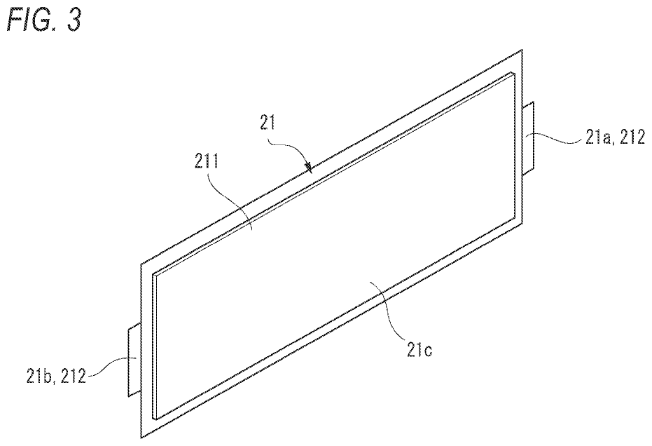

Each of the laminated cells 21 is, for example, a solid-state battery. As illustrated in FIG. 3, the laminated cell 21 formed of the solid-state battery includes a positive electrode to which a positive electrode tab 21a is coupled, a negative electrode to which a negative electrode tab 21b is coupled, a solid electrolyte disposed between the positive electrode and the negative electrode, and a laminate film 21c which accommodates these, and performs charging and discharging by giving and receiving lithium ions between the positive electrode and the negative electrode via the solid electrolyte. Hereinafter, a portion of the laminated cell 21 provided between the positive electrode tab 21a and the negative electrode tab 21b is also referred to as a cell body portion 211. When the positive electrode tab 21a and the negative electrode tab 21b are not distinguished from each other, the positive electrode tab 21a and the negative electrode tab 21b are also collectively referred to as a cell terminal 212.

The solid electrolyte is not particularly limited as long as the solid electrolyte has lithium ion conductivity and insulating properties, and a material generally used for an all-solid-state lithium-ion battery may be used. Examples thereof include inorganic solid electrolytes such as sulfide solid electrolyte materials, oxide solid electrolyte materials, and lithium-containing salts, polymer-based solid electrolytes such as polyethylene oxide, and gel-based solid electrolytes containing lithium-containing salts or lithium ion conductive ionic liquids. A form of a solid electrolyte material is not particularly limited, and examples thereof include a particulate form.

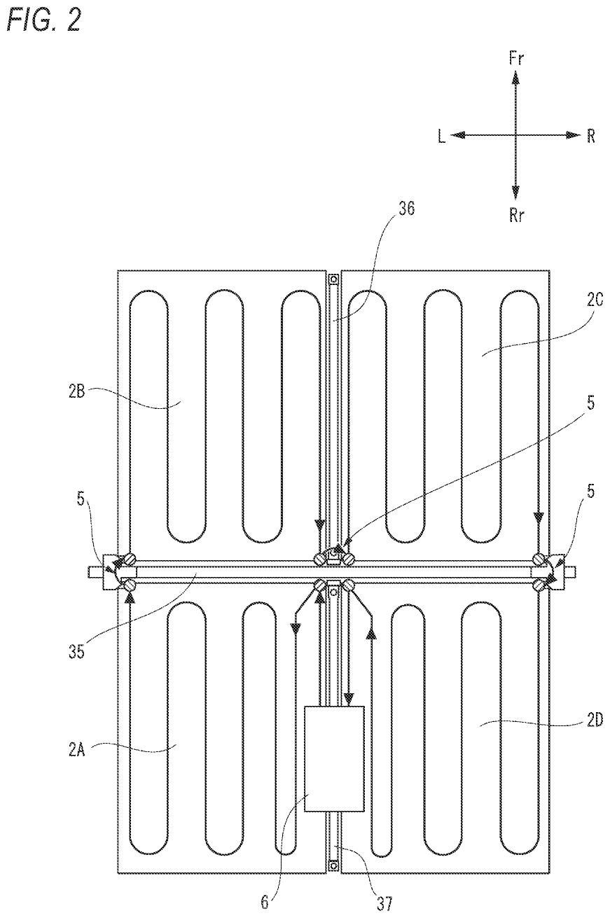

As illustrated in FIGS. 1 and 2, the plurality of laminated cells 21 are divided into a plurality of cell groups 2A to 2D. For example, the battery case 3 is divided into a first cell group 2A disposed at a left rear portion of the battery case 3, a second cell group 2B disposed at a left front portion of the battery case 3, a third cell group 2C disposed at a right front portion of the battery case 3, and a fourth cell group 2D disposed at a right rear portion of the battery case 3. The plurality of cell groups 2A to 2D are arranged at predetermined intervals in the horizontal direction.

Although not illustrated, in each of the cell groups 2A to 2D, the plurality of laminated cells 21 are restrained in a direction in which the plurality of laminated cells 21 are stacked (hereinafter, also referred to as a stacking direction) by a restraining device such as a binding band. This restricts movement of the plurality of laminated cells 21 in the stacking direction. The restraining device can take various forms. For example, partition walls may be provided at both end portions of each of the cell groups 2A to 2D to restrain the plurality of laminated cells 21 in the stacking direction.

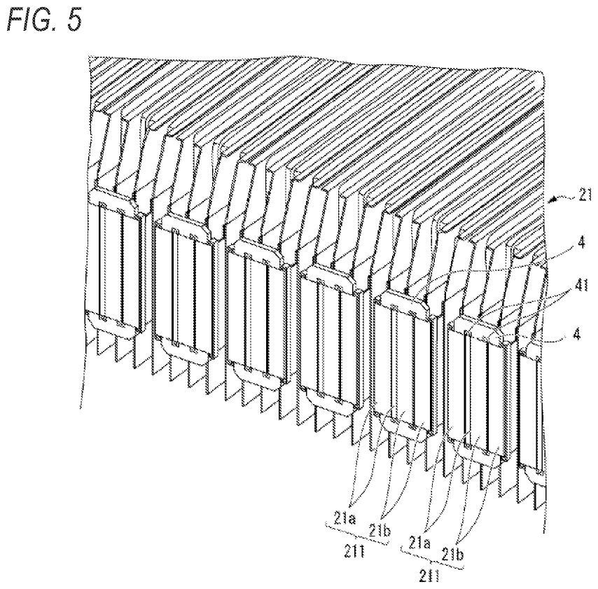

In the plurality of laminated cells 21 constituting the cell groups 2A to 2D, two adjacent laminated cells 21, 21 are coupled in parallel, and the laminated cells 21, 21 coupled in parallel are electrically coupled in series to adjacent laminated cells 21, 21 coupled in parallel. In the embodiment, as illustrated in FIG. 5, adjacent laminated cells 21, 21 are coupled in parallel via an inter-cell coupling member 4, and further adjacent laminated cells 21, 21 are coupled in parallel via the inter-cell coupling member 4, so that the laminated cells 21, 21 coupled in parallel and the laminated cells 21, 21 adjacent thereto are coupled in series.

More specifically, the inter-cell coupling member 4 is a plate-shaped member and has two openings 41. The negative electrode tab 21b inserted through one opening 41 and the negative electrode tab 21b extending from one side of the inter-cell coupling member 4 are bent at 90° from the one side to be prevented from coming off, the positive electrode tab 21a inserted through the other opening 41 and the positive electrode tab 21a extending from the other side of the inter-cell coupling member 4 are bent at 90° from the other side to be prevented from coming off, and the tabs 21b, 21b, 21a, and 21a are joined to the inter-cell coupling member 4 in a state where the negative electrode tab 21b inserted through the one opening 41 and the positive electrode tab 21a inserted through the other opening 41 are overlapped with each other. In the plurality of laminated cells 21 constituting the cell groups 2A to 2D, all cells may be coupled in series, and a coupling method is not limited.

Returning to FIG. 2, the cell groups 2A to 2D are electrically coupled in series via conductive coupling members 5. For example, an electrical flow path start of the first cell group 2A is coupled to a wiring coupling box 6, and an electrical flow path end of the first cell group 2A is coupled to an electrical flow path start of the second cell group 2B via a conductive coupling member 5. An electrical flow path end of the second cell group 2B is coupled to an electrical flow path start of the third cell group 2C via a conductive coupling member 5, and an electrical flow path end of the third cell group 2C is coupled to an electrical flow path start of the fourth cell group 2D via a conductive coupling member 5. An electrical flow path end of the fourth cell group 2D is coupled to the wiring coupling box 6.

As illustrated in FIG. 1, the battery case 3 has a lattice-shaped frame structure in a plan view. As illustrated in FIGS. 1 and 2, the frame structure includes a pair of side frames 31 and 32 facing each other in the left-right direction so as to sandwich the cell groups 2A to 2D, a front frame 33 and a rear frame 34 facing each other in a front-rear direction so as to sandwich the cell groups 2A to 2D, an intermediate horizontal frame 35 disposed between the first cell group 2A and the second cell group 2B and between the third cell group 2C and the fourth cell group 2D, a first intermediate vertical frame 36 disposed between the second cell group 2B and the third cell group 2C, and a second intermediate vertical frame 37 disposed between the first cell group 2A and the fourth cell group 2D. The intermediate horizontal frame 35 includes an upper intermediate horizontal frame 351 and a lower intermediate horizontal frame 352. According to such a battery case 3, not only deformation of the battery case 3 at the time of collision can be prevented, but also the cell groups 2A to 2D can be protected from impact at the time of collision. Although not illustrated in the drawings, the pair of side frames 31, 32, the front frame 33, and the rear frame 34 have a predetermined length in an upper-lower direction and constitute side wall portions.

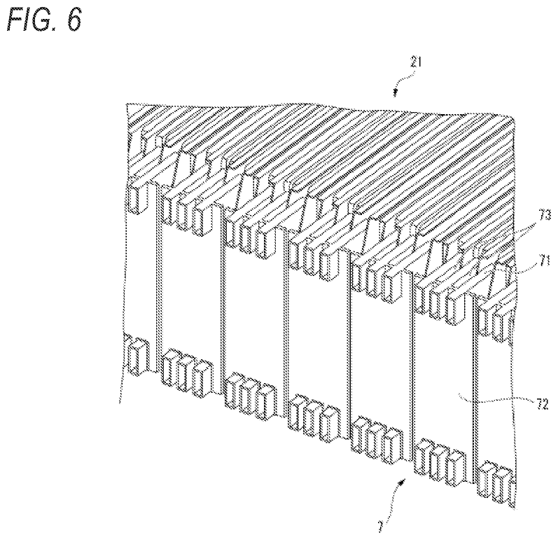

Stopper members 7 as illustrated in FIG. 6 are disposed between the plurality of laminated cells 21 and the frame structure (specifically, the front frame 33, the rear frame 34, and the intermediate horizontal frame 35) facing the cell terminals 212 in a direction orthogonal to the stacking direction of the horizontal direction (in the embodiment, the front-rear direction, hereinafter also referred to as a stacking orthogonal direction). Each of the stopper members 7 restricts movement of the plurality of laminated cells 21 in the stacking orthogonal direction, for example, at the time of collision of the vehicle.

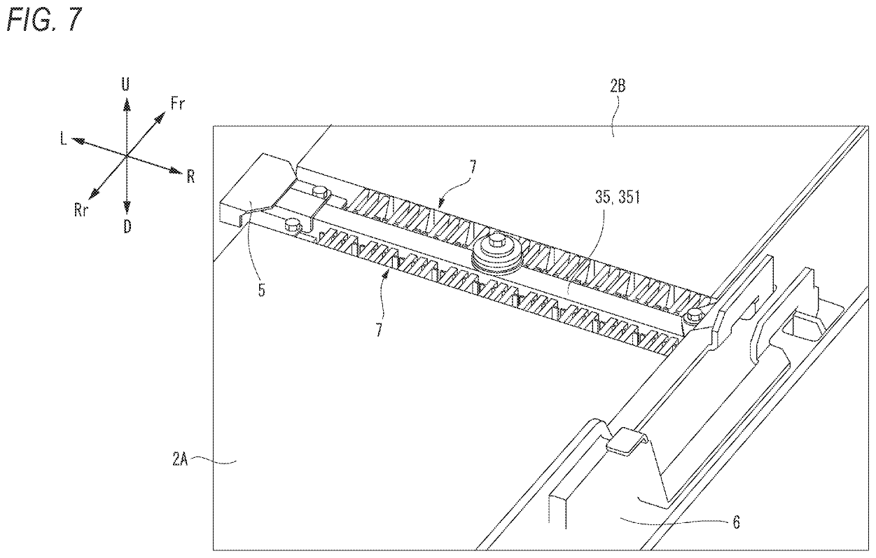

Specifically, as illustrated in FIG. 7, the stopper member 7 is disposed between a front end portion of the first cell group 2A (that is, a cell terminal 212 side) and the intermediate horizontal frame 35. Although not illustrated, the stopper member 7 is also disposed between a rear end portion of the first cell group 2A (a cell terminal 212 side) and the rear frame 34. Similarly, the stopper member 7 is also disposed between a front end portion of the second cell group 2B and the front frame 33 and between a rear end portion of the second cell group 2B and the intermediate horizontal frame 35. The stopper member 7 is also disposed between a front end portion of the third cell group 2C and the front frame 33 and between a rear end portion of the third cell group 2C and the intermediate horizontal frame 35. The stopper member 7 is also disposed between a front end portion of the fourth cell group 2D and the intermediate horizontal frame 35 and between a rear end portion of the fourth cell group 2D and the rear frame 34.

(Stopper Member)

Next, the stopper member 7 will be described in detail with reference to FIGS. 6 to 10. The stopper member 7 disposed between the intermediate horizontal frame 35 and the plurality of laminated cells 21 as illustrated in FIG. 7 will be described below. The stopper member 7 disposed between the front frame 33 and the plurality of laminated cells 21 and the stopper member 7 disposed between the rear frame 34 and the plurality of laminated cells 21 also have a similar configuration.

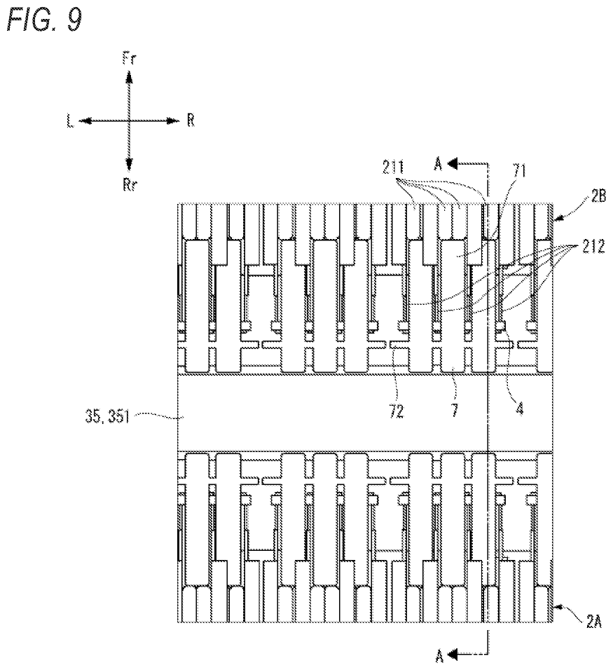

As illustrated in FIGS. 6 and 9, a plurality of stopper members 7 are provided adjacent to each other along the stacking direction of the plurality of laminated cells 21. The stopper members 7 are in one-to-one correspondence with inter-cell coupling members 4, that is, one stopper member 7 faces one inter-cell coupling member 4.

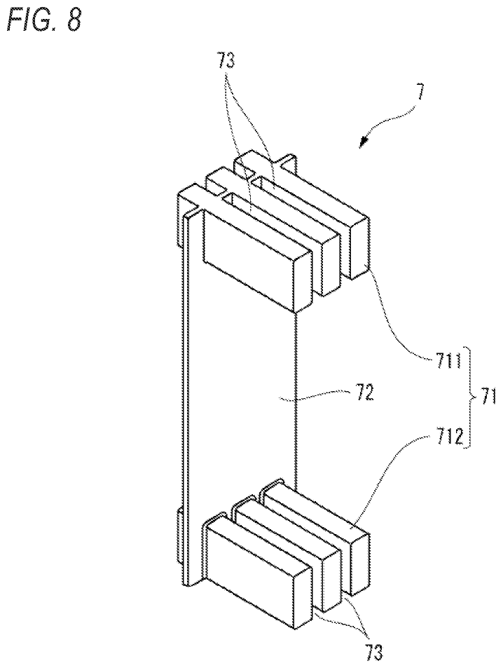

As illustrated in FIG. 8, the stopper member 7 has an abutting portion 71. The abutting portion 71 includes an upper abutting portion 711 and a lower abutting portion 712. The stopper member 7 includes a coupling portion 72 which couples the upper abutting portion 711 and the lower abutting portion 712.

As illustrated in FIG. 3, the cell terminal 212 of the laminated cell 21 extends from a central portion of the cell body portion 211 in the upper-lower direction in the stacking orthogonal direction, and has a length in the upper-lower direction shorter than that of the cell body portion 211. Therefore, spaces are formed at an upper side and at a lower side of the cell terminal 212. As illustrated in FIGS. 6, 9, and 10, abutting portions 71 are disposed in spaces at the upper side and at the lower side of the cell terminal 212 and between the cell body portion 211 and the intermediate horizontal frame 35.

The abutting portion 71 abuts against the cell body portion 211 and the intermediate horizontal frame 35. Specifically, the upper abutting portion 711 abuts against the upper intermediate horizontal frame 351, and the lower abutting portion 712 abuts against the lower intermediate horizontal frame 352.

With such a configuration, it is possible to restrict movement of the plurality of laminated cells 21 in the stacking orthogonal direction, and to prevent displacement of the plurality of laminated cells 21 in the same direction.

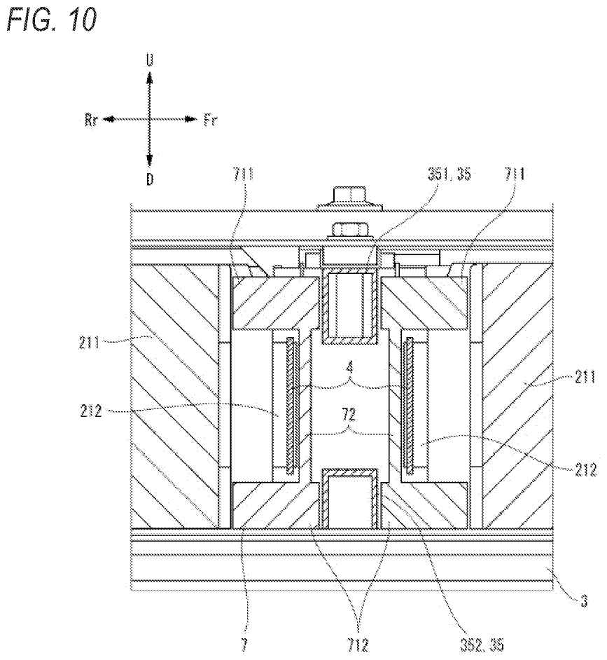

As illustrated in FIG. 10, the inter-cell coupling member 4 is disposed between the upper abutting portion 711 and the lower abutting portion 712. Therefore, the abutting portion 71 and the inter-cell coupling member 4 do not interfere with each other. The coupling portion 72 is disposed between the inter-cell coupling member 4 and the intermediate horizontal frame 35 in the stacking orthogonal direction. Therefore, the coupling portion 72 can prevent interference between the inter-cell coupling member 4 and the intermediate horizontal frame 35.

Slits 73 extending in the stacking orthogonal direction is formed in the abutting portion 71. A part of an edge portion of the cell body portion 211 can be disposed in the slits 73, and the cell body portion 211 and the abutting portion 71 are configured not to interfere with each other.

Further, the stopper member 7 preferably has insulating properties. Accordingly, the intermediate horizontal frame 35 can be insulated from the cell terminals 212 and the inter-cell coupling member 4.

(Modification)

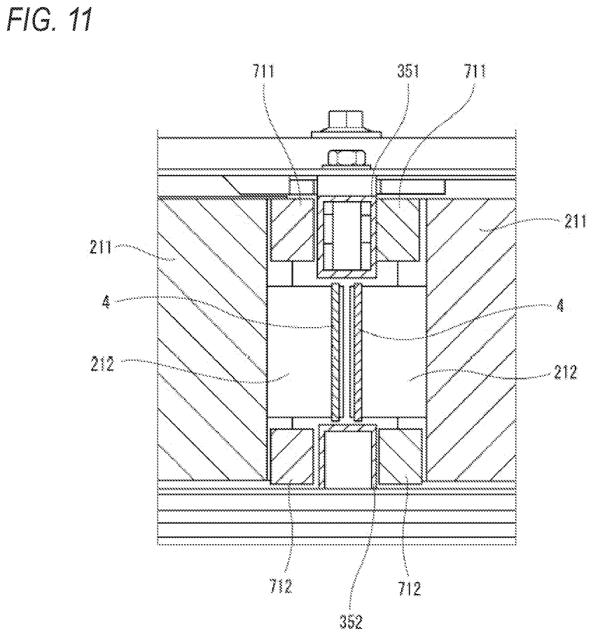

In a modification illustrated in FIG. 11, the stopper member 7 does not include the coupling portion 72, and the upper abutting portion 711 and the lower abutting portion 712 are independently disposed in the spaces at the upper side and at the lower side of the cell terminal 212 and between the cell body portion 211 and the intermediate horizontal frame 35.

Since the stopper member 7 according to the modification is not provided with the coupling portion 72, the inter-cell coupling member 4 can be disposed between the upper intermediate horizontal frame 351 and the lower intermediate horizontal frame 352. Accordingly, space saving can be achieved in the stacking orthogonal direction.

Although various embodiments have been described above with reference to the drawings, it is needless to say that the present invention is not limited to such an example. It is apparent to those skilled in the art that various changes and modifications can be conceived within the scope of the claims, and it is also understood that such changes and modifications naturally belong to the technical scope of the present invention. Components in the embodiment described above may be combined freely within a range not departing from the spirit of the invention.

For example, in the above-described embodiment and modification, the stopper member 7 includes the upper abutting portion 711 and the lower abutting portion 712, but the present disclosure is not limited thereto. For example, the stopper member 7 may have a configuration including only the upper abutting portion 711, a configuration including only the lower abutting portion 712, a configuration including the upper abutting portion 711 and the coupling portion 72, or a configuration including the lower abutting portion 712 and the coupling portion 72. According to the configuration without the lower abutting portion 712, the stopper member 7 can be fitted between the frame structure and the cell body portion 211 from an upper side after the plurality of laminated cells 21 are arranged in the battery case 3.

In the above-described embodiment and modification, the cell terminal 212 of the laminated cell 21 extends in the stacking orthogonal direction from the central portion of the cell body portion 211 in the upper-lower direction, but the present disclosure is not limited thereto. For example, the cell terminal 212 may extend in the stacking orthogonal direction from a lower portion or an upper portion of the cell body portion 211 in the upper-lower direction. In this case, the abutting portion 71 of the stopper member 7 may be disposed in a space at the upper side or at the lower side of the cell terminal 212.

In the above-described embodiment and modification, the stopper members 7 are provided at both ends of the laminated cell 21 in the stacking orthogonal direction, but the present disclosure is not limited thereto. The stopper member 7 may be provided only at one end of the laminated cell 21 in the stacking orthogonal direction. For example, when the positive electrode tab 21a and the negative electrode tab 21b of the laminated cell 21 extend from one end of the laminated cell 21 in the stacking orthogonal direction, the stopper member 7 may be provided only at one end of the laminated cell 21 in the stacking orthogonal direction.

In the above-described embodiment and modification, a plurality of stopper members 7 are disposed between the frame structure of the battery case 3 and the plurality of laminated cells 21, but the present disclosure is not limited thereto. For example, one stopper member 7 extending in the stacking direction may be disposed between the frame structure and the plurality of laminated cells 21.

In the above-described embodiment and modification, the abutting portion 71 is configured to abut against the cell body portion 211 and the frame structure of the battery case 3, but slight gaps may be formed between the abutting portion 71 and the cell body portion 211 and between the abutting portion 71 and the frame structure. Accordingly, it is possible to prevent a large load from being applied to the laminated cell 21 from the stacking orthogonal direction.

At least the following matters are described in the present specification. Although the corresponding components or the like in the above embodiment are shown in parentheses, the present invention is not limited thereto.

(1) A battery pack (battery pack 1) including:
a plurality of laminated cells (laminated cells 21) stacked in a first direction (stacking direction) of a horizontal direction; and
a battery case (battery case 3) accommodating the plurality of laminated cells, in which:
each of the laminated cells includes:
   a cell body portion (cell body portion 211); and
   a cell terminal (cell terminal 212) extending from the cell body portion in a second direction (stacking orthogonal direction) orthogonal to the first direction of the horizontal direction and having a length in an upper-lower direction shorter than that of the cell body portion;
the battery case includes a frame member (front frame 33, rear frame 34, intermediate horizontal frame 35) facing the cell terminal in the second direction; and
a stopper member (stopper member 7) is disposed in at least one of a space at an upper side of the cell terminal and a space at a lower side of the cell terminal and between the cell body portion and the frame member.

According to (1), since the stopper member is disposed in at least one of the space at the upper side of the cell terminal and the space at the lower side of the cell terminal and between the cell body portion and the frame member, it is possible to prevent the laminated cell from being displaced in a direction orthogonal to the stacking direction.

(2) The battery pack according to (1), in which
the frame member is a side wall portion (front frame 33, rear frame 34) of the battery case or a cross member (intermediate horizontal frame 35) provided inside the battery case.

According to (2), since the stopper member is disposed between the cell body portion and the side wall portion of the battery case, or between the cell body portion and the cross member of the battery case, the laminated cell can be disposed inside the battery case without being displaced in a direction orthogonal to the stacking direction.

(3) The battery pack according to (1) or (2), in which
the stopper member has insulating properties.

According to (3), since the stopper member has insulating properties, insulation between the laminated cell and the frame structure can be ensured:

4) The battery pack according to any one of (1) to (3), further including:
a conductive coupling member (inter-cell coupling member 4) being plate-shaped and electrically coupling the plurality of laminated cells to each other, in which:
the stopper member is disposed in the space and between the cell body portion and the frame member, and includes an abutting portion (abutting portion 71) configured to abut against the frame member and the cell body portion; and
the abutting portion is disposed at a position different from a position of the conductive coupling member in the upper-lower direction.

According to (4), since the abutting portion of the stopper member is disposed at the position different from the position of the conductive coupling member in the upper-lower direction, it is possible to prevent interference between the abutting portion and the conductive coupling member.

(5) The battery pack according to (4), in which
the abutting portion is disposed only in a space at the upper side of the cell terminal and between the cell body portion and the frame member.

According to (5), since the abutting portion is disposed only in the space at the upper side of the cell terminal and between the cell body portion and the frame member, the stopper member can be fitted between the frame structure and the cell body portion from the upper side after the laminated cells are arranged in the battery case.

(6) The battery pack according to (4), in which
the abutting portion includes
   an upper abutting portion (upper abutting portion 711) disposed at an upper side of the conductive coupling member, and
   a lower abutting portion (lower abutting portion 712) disposed at a lower side of the conductive coupling member.

According to (6), since the abutting portion includes the upper abutting portion and the lower abutting portion, the abutting portion abuts against the frame member and the cell body portion from the upper side and the lower side of the cell terminal, and it is possible to prevent the laminated cell from being displaced in the stacking orthogonal direction.

(7) The battery pack according to (6), in which
the stopper member further includes a coupling portion coupling the upper abutting portion and the lower abutting portion.

According to (7), since the upper abutting portion and the lower abutting portion are coupled, the upper abutting portion and the lower abutting portion can have an integrated structure.

(8) The battery pack according to any one of (4) to (7), in which:
the conductive coupling member has an opening (opening 41) through which the cell terminal is inserted; and
the cell terminal is coupled to the conductive coupling member by being inserted into the opening and bent.

According to (8), the cell terminal can be coupled to the conductive coupling member by being inserted into the opening of the conductive coupling member and bent. Therefore, the cell terminal and the conductive coupling member can be coupled with a simple configuration.

(9) The battery pack according to any one of (1) to (8), in which
the plurality of laminated cells are restrained in a stacking direction.

According to (9), since the plurality of laminated cells are restrained in the stacking direction, displacement of the laminated cells in the stacking direction can be prevented.

(10) The battery pack according to any one of (1) to (9), in which
the laminated cell is a solid-state battery.

According to (10), since an energy density is high, a larger number of laminated cells can be arranged.

What is claimed is:

1. A battery pack comprising:
a plurality of laminated cells stacked in a first direction of a horizontal direction; and
a battery case accommodating the plurality of laminated cells, wherein:
each of the laminated cells includes:
a cell body portion; and
a cell terminal extending from the cell body portion in a second direction orthogonal to the first direction of the horizontal direction and having a length in an upper-lower direction shorter than that of the cell body portion;
the battery case includes a frame member facing the cell terminal in the second direction; and
a stopper member is disposed in at least one of a space at an upper side of the cell terminal and a space at a lower side of the cell terminal and between the cell body portion and the frame member.

2. The battery pack according to claim 1, wherein
the frame member is a side wall portion of the battery case or a cross member provided inside the battery case.

3. The battery pack according to claim 1, wherein
the stopper member has insulating properties.

4. The battery pack according to claim 1, further comprising:
a conductive coupling member being plate-shaped and electrically coupling the plurality of laminated cells to each other, wherein:
the stopper member is disposed in the space and between the cell body portion and the frame member, and includes an abutting portion configured to abut against the frame member and the cell body portion; and
the abutting portion is disposed at a position different from a position of the conductive coupling member in the upper-lower direction.

5. The battery pack according to claim 4, wherein
the abutting portion is disposed only in a space at the upper side of the cell terminal and between the cell body portion and the frame member.

6. The battery pack according to claim 4, wherein
the abutting portion includes:
an upper abutting portion disposed at an upper side of the conductive coupling member; and
a lower abutting portion disposed at a lower side of the conductive coupling member.

7. The battery pack according to claim 6, wherein
the stopper member further includes a coupling portion coupling the upper abutting portion and the lower abutting portion.

8. The battery pack according to claim 4, wherein:
the conductive coupling member has an opening through which the cell terminal is inserted; and
the cell terminal is coupled to the conductive coupling member by being inserted into the opening and bent.

9. The battery pack according to claim 1, wherein
the plurality of laminated cells are restrained in a stacking direction.

10. The battery pack according to claim 1, wherein
the laminated cell is a solid-state battery.
